(19) United States
(12) Patent Application Publication
(10) Pub. No.: US 2002/0081071 A1
(43) Pub. Date: Jun. 27, 2002

(54) Vacuum spaced etalon

(76) Inventor: Francis S. Maldari, Andover, MA (US)

Correspondence Address: Pennie & Edmonds, LLP, 3300 Hillview Avenue, Palo Alto, CA, 94304, US

(21) Appl. No.: 10/011,617

(22) Filed: Nov. 5, 2001

Related U.S. Application Data
(60) Provisional application No. 60/245,909, filed on Nov. 3, 2000.

(51) Int. Cl. G02B 6/26; G02B 27/00

(52) U.S. Cl. 385/39; 385/73; 359/578

(57) ABSTRACT

A vacuum spaced etalon comprises a spacer and two faceplates on two opposite sides of the spacer, the two faceplates each having an inner surface and an outer surface, a reflective coating covering at least a portion of the inner surface of each faceplate and an anti-reflective coating covering the outer surface of each faceplate. The spacer is in contact with an edge portion of the inner surface of each faceplate, whereby the faceplates and the spacer together form a cavity that is evacuated to provide a vacuum.

This application claims priority to provisional Patent Application No. 60/245,909.

The present invention relates generally to fiber communications technology, and particularly to etalons used in fibre communications systems.

### BACKGROUND OF THE INVENTION

Implementation of Wavelength Division Multiplexing (WDM) and Dense Wavelength Division Multiplexing (DWDM) technology in fiber communications systems has led to increasing use of wavelength tunable lasers for transmission of optical signals. Wavelength tunable lasers are cost-effective and provide for a flexible system architecture in which wavelength channels can be provided when and where needed. However, the use of tunable lasers requires that the laser wavelength remains stable over time.

One technique for maintaining a stable laser wavelength is wavelength locking. To achieve wavelength locking, part of an optical signal is tapped off and passed through an etalon. The signal from the etalon is compared to a reference signal and the laser is adjusted if the wavelength is incorrect. With the development of dense WDM technology, the requirements for maintaining a wavelength have become so stringent that thermal effects, such as the physical expansion of etalon support structure and the change in refractive index of the air with temperature, are an issue. Therefore, there is a need for a thermally stable etalon that can operate in the range of wavelengths in the full C-band commonly used for optical fiber communications.

### SUMMARY OF THE INVENTION

In summary, the present invention includes a vacuum spaced etalon comprising two faceplates each having an inner surface and an outer surface, a reflective coating covering at least a portion of the inner surface of each faceplate and an anti-reflective coating covering at least a portion of the outer surface of each faceplate. The faceplates are separated by a spacer such that the two faceplates are on two opposite sides of and in contact with the spacer. The two faceplates and the spacer together form a cavity that is evacuated to provide a vacuum.

The present invention also includes a system and method for assembling the faceplates and the spacer to form the vacuum spaced etalon. The system comprises a vacuum chamber having a base and a side wall, the side wall having a feedthrough for attaching a linear actuator. The system further comprises a shaft having one end coupled to the linear actuator through a coupler, and the other end attached to a press plate. The system further comprises a backing plate attached to the base of the chamber, and a holder for supporting the faceplates and the spacer between the press plate and the backing plate, so that when the press plate is pushed toward the backing plate using the linear actuator, the faceplates and the spacer are pressed together to form the vacuum spaced etalon. The method comprises the steps of arranging the faceplates and the spacer on the holder between the press plate and the backing plate, pumping the vacuum chamber to a base pressure, pressing the faceplates and the spacer together to form the etalon, venting the vacuum chamber to atomospheric pressure, and removing the etalon from the vacuum chamber.

The present invention also includes an optical fiber assembly comprising the vacuum spaced etalon, a first fiber for outputting a light signal to the etalon, a second fiber for receiving an output signal from the etalon, a first graded index reflection lens in between the first fiber and the first faceplate of the etalon for collimating the light signal from the first fiber; and a second graded index reflection lens for focusing the output signal from the etalon and for coupling the output signal into the second fiber.

The present invention also includes a silicon optical bench for use in a wavelength locker system to stabilize the wavelength of tunable laser diodes used for fiber optics communication, comprising the vacuum spaced etalon, a silicon substrate that supports the etalon, a beamsplitter disposed on the silicon substrate, the beamsplitter having four sides facing four different directions with a first side facing the etalon. The optical bench further comprises an input fiber array directing signals toward a second side of the beamsplitter, the second side facing a direction perpendicular to the direction faced by the first side of the beamsplitter, and a collimater disposed in between the input fiber and the beamsplitter. The optical bench further comprises a first output fiber array for receiving signals from a third side of the beamsplitter, the third side being opposite to the second side of the beamsplitter, and a fiber coupler disposed in between the beamsplitter and the first output fiber array. The optical bench further comprises a second output fiber array for receiving signals from the etalon; and a fiber coupler disposed in between the etalon and the second output fiber array.

One advantage of using the vacuum spaced etalon for wavelength locking is that it eliminates thermal effects caused by the change in refractive index of the air with temperature. Another advantage is that the vacuum spaced etalon is much more robust that conventional etalons because of the enormous pressure difference outside and inside of the etalon.

### BRIEF DESCRIPTION OF THE DRAWINGS

Additional objects and features of the invention will be more readily apparent from the following detailed description and appended claims when taken in conjunction with the drawings, in which:

FIG. 1 is a block diagram illustrating a vacuum space etalon according to one embodiment of the present invention;

FIG. 2 is a block diagram illustrating a multilayer anti-reflection coating according to one embodiment of the present invention;

FIG. 3 is a block diagram illustrating a multilayer reflective coating according to one embodiment of the present invention;

FIG. 4 is a diagram illustrating a faceplates and spacer assembly for forming the etalon according to one embodiment of the present invention;

FIG. 4A is a diagram of a system for assembling the etalon according to one embodiment of the present invention;

FIG. 4B is a diagram showing a cross section of the etalon on an assembly fixture in the system for assembling the etalon according to one embodiment of the present invention;

FIG. 4C is a flow chart illustrating a process of assembling the etalon according to one embodiment of the present invention;

FIG. 5 is a block diagram of an optical fiber assembly according to one embodiment of the present invention;

FIG. 6 is a plot of the reflectance of the multilayer reflective coating in accordance with one embodiment of the invention;

FIG. 7 is a table showing the entire range of wavelengths in the International Telecommunication Union's standard ITU-T DWDM grid;

FIG. 8 is a block diagram of a silicon optical bench incorporating the vacuum spaced etalon according to one embodiment of the present invention;

FIG. 9 is a diagram of the cross-section of a fiber array comprising nine input fibers placed in V-grooves on a silicon optical bench.

### DESCRIPTION OF THE PREFERRED EMBODIMENTS

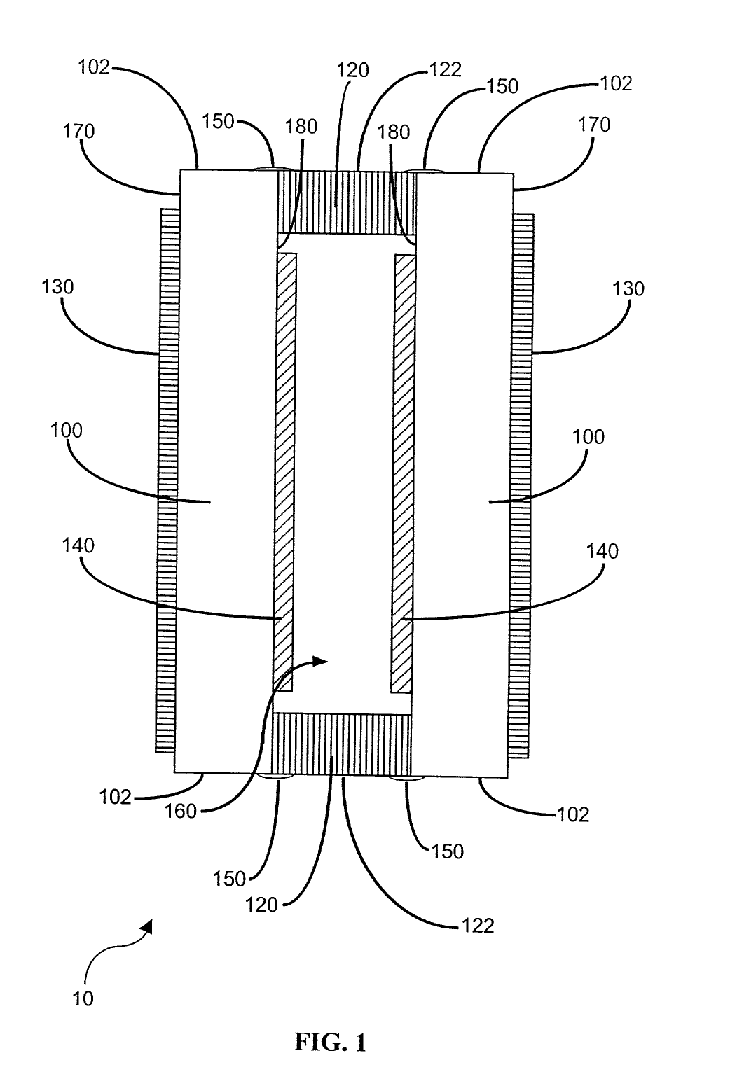

FIG. 1 shows an etalon 10 in accordance with the invention. The etalon comprises two substrates or faceplates 100 separated by a spacer 120. Each faceplate 100 has an inner surface 180, an outer surface 170, and an outer edge 102. The spacer 120 also has an edge 122. The areas where the edge 122 of spacer 120 and the outer edges 102 of the faceplates 100 meet are sealed using a sealing compound 150. Spacer 120 and faceplates 100 form a sealed cavity 160 that is evacuated to provide a vacuum. In one embodiment, the vacuum within the cavity is on the order of 10⁻⁶ torr.

In one embodiment, faceplates 100 are circular discs. Faceplates 100 can be any material that is optically transparent in a desired wavelength region. Illustratively, faceplates 100 are composed of fused silica, optical crown glass, BK7 glass or zinc selenide. Inner surfaces 180 of faceplates 100 are parallel to each other. The outer surface 170 of each face plate 100 is at a slight angle to the inner surface 180 so that unwanted reflection from the outer surfaces is minimized. Both the inner and the outer surfaces are optically polished, with the outer surface polish being λ/10, 10⁻⁵ scratch-dig and the inner surface polish being λ/100, 10⁻⁵ scratch-dig, where λ is a predetermined wavelength. In one embodiment of the present invention, λ is chosen to be a center wavelength in the C-band and λ=1.55 μm.

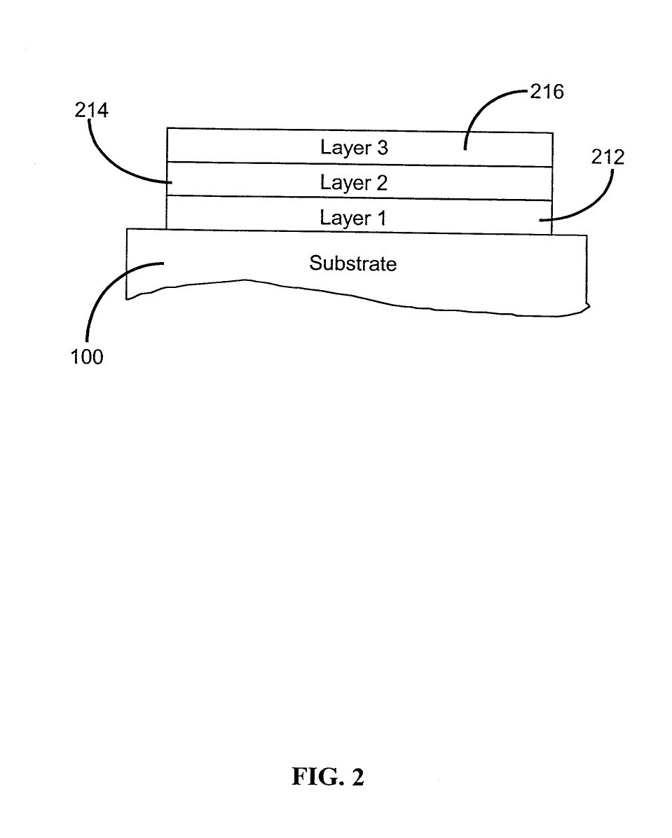

The outer surfaces 170 of faceplates 100 have an anti-reflection coating 130. The anti-reflection coating 130 comprises multiple layers of dielectric materials. FIG. 2 illustrates an anti-reflection coating in accordance with one embodiment of the invention. In this embodiment, the anti-reflection coating comprises three layers, layer 212 closest to the face plate being Al₂O₃, the middle layer 214 being Ta₂O₅ and the outermost layer 216 being MgF₂. The thicknesses of the three layers are 214.77 nm, 318.58 nm and 253.18 nm respectively.

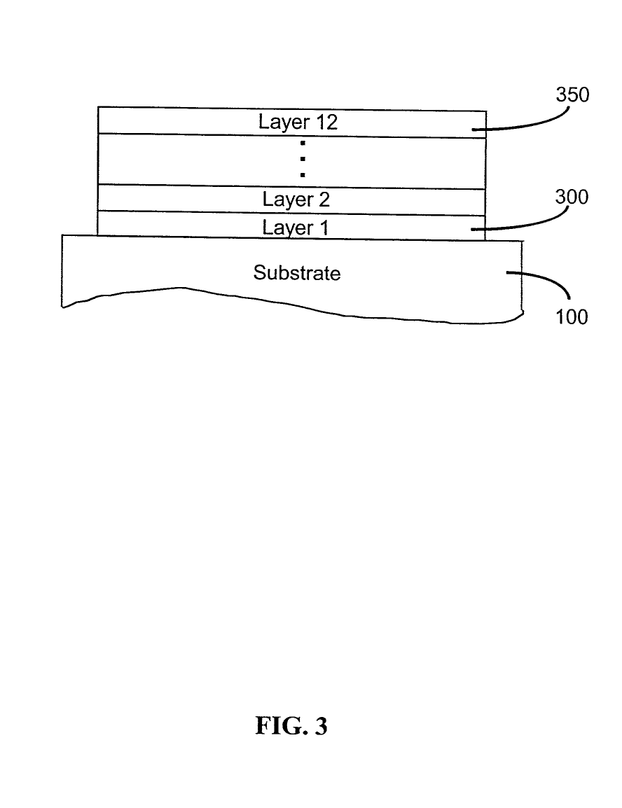

The inner surfaces 180 of faceplates 100 have a reflective coating 140. In one embodiment, the reflective coating comprises multiple layers of dielectric materials, the dielectric materials being Ta₂O₅ and SiO₂. FIG. 3 shows the structure of a reflective coating 140 in accordance with one embodiment of the invention. The coating 140 comprises alternating layers of Ta₂O₅ and SiO₂, the layer 300 closest to the face plate being Ta₂O₅ and outermost layer 350 being SiO₂. The composition and thickness of each layer of reflective coating 140 are given in Table 1. When the reflective coating 140 is applies on each of the inner surfaces 180, a mask can be used to prevent coating material from depositing on where the inner surfaces 180 should contact with the spacer 120.

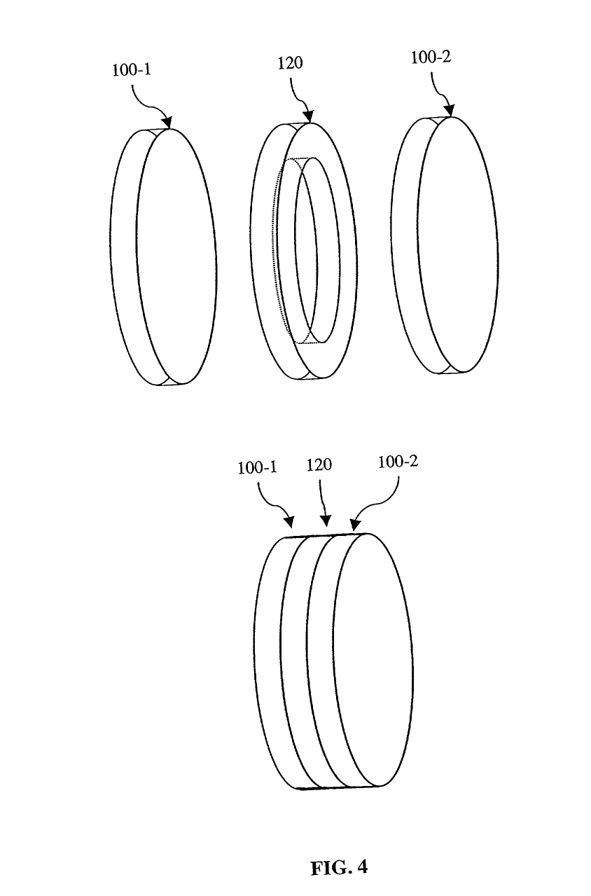

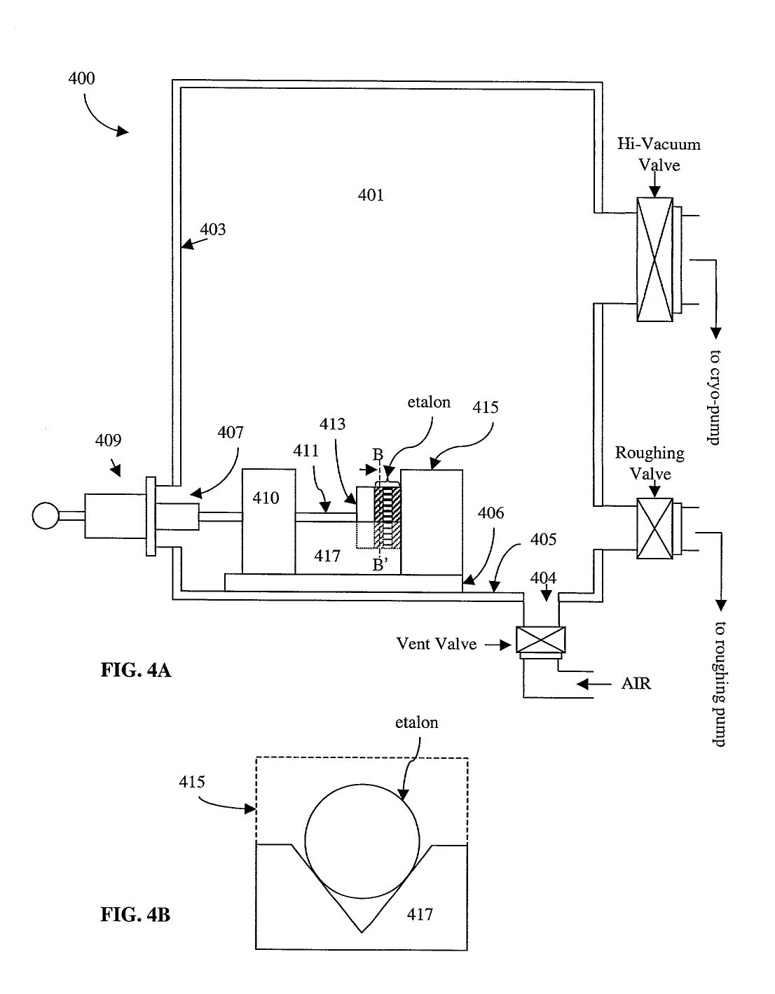

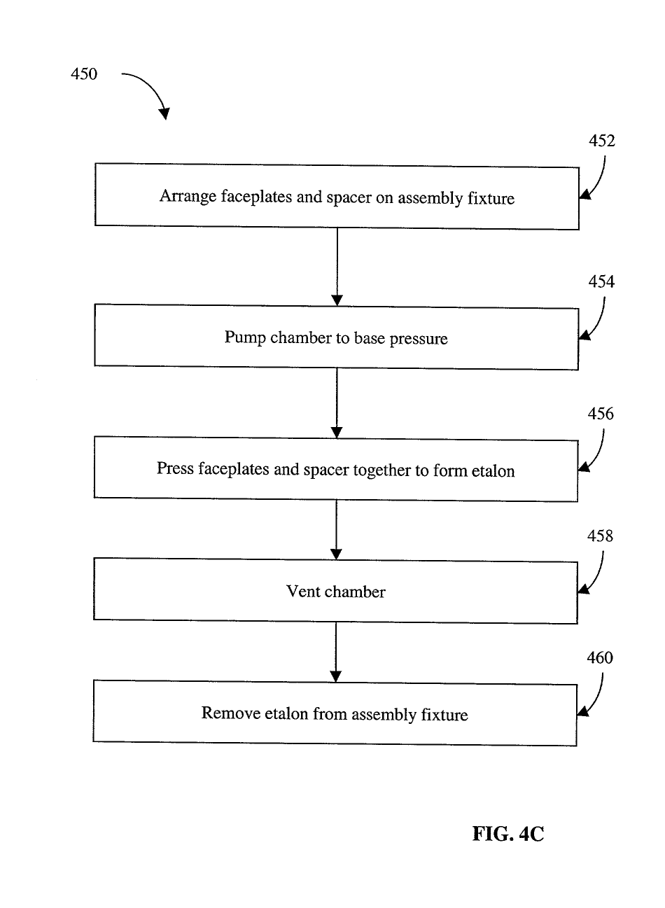

Preferably, spacer 120 is an annulus having an outer diameter that is the same as the diameter of faceplates 100. In one embodiment of the present invention, the hole in the center of the annulus is 2 mm in diameter. FIG. 4 more clearly illustrates the faceplates and spacer assembly of the etalon. Faceplate 100-1 is on one side of and in contact with spacer 120, face plate 100-2 is on the other side of and in contact with spacer 120. The outer edges of face plate 100-1 and spacer 120 are sealed with sealing compound 150. Similarly, the outer edges of face plate 100-2 and spacer 120 are sealed with sealing compound 150.

Spacer 120 is any thermally stable material and need not be transparent in the desired wavelength region. In one embodiment, spacer 120 is ULE Corning 7940 material. Sealing compound 150 is also a thermally stable material and need not be transparent in the desired wavelength region. In one embodiment, the sealing compound 150 is Norland 61. In another embodiment, the sealing compound 150 is Norland 68. Surfaces of the spacer 120 which are in contact with the faceplates are also polished to a flatness of λ/50, where λ is a predetermined wavelength. In one embodiment of the present invention, λ is chosen to be a center wavelength in the C-band and λ=1.55 μm.

TABLE 1

| Layer | Material | Thickness (nanometers) |
|---|---|---|
| 1 | Ta₂O₅ | 210.51 |
| 2 | SiO₂ | 247.76 |
| 3 | Ta₂O₅ | 143.82 |
| 4 | SiO₂ | 245.99 |
| 5 | Ta₂O₅ | 190.74 |
| 6 | SiO₂ | 237.85 |
| 7 | Ta₂O₅ | 210.44 |
| 8 | SiO₂ | 274.97 |
| 9 | Ta₂O₅ | 283.88 |
| 10 | SiO₂ | 911.63 |
| 11 | Ta₂O₅ | 431.40 |
| 12 | SiO₂ | 312.41 |

FIG. 4A illustrates a system 400 for assembling a vacuum spaced etalon according to one embodiment of the present invention. The system 400 comprises a vacuum chamber 401 having a base 405 and a side wall 403, the side wall 403 having a feedthrough 407 for attaching a linear actuator 409, the base having a vent 404 controlled by a vent valve. In one embodiment of the present invention, the linear actuator 409 is a MDC SLM-275 actuator manufactured by MDC vacuum products. It facilitates push-pull motion through a feedthrough of a vacuum chamber. The system 400 further comprises a shaft 411 having one end coupled to the linear actuator through a coupler 410 and the other end coupled to a press plate 413. The system 400 further comprises a backing plate 415 attached to the base 405 of the chamber 401 through a base plate 406. The system 410 also comprises a holder 417 for supporting the faceplates and the spacer of the etalon between the press plate and the backing plate. The holder 417, the backing plate 415, the press plate 413, the shaft 411, the coupler 410 and the linear actuator 409 together form an assembly fixture for assembling the faceplates and the spacer into a vacuum spaced etalon in the vacuum chamber 401. In one embodiment of the present invention, the holder 417 has a V-shaped grove such that the faceplates and spacer of the etalon are aligned when they are placed on the holder. FIG. 4B shows a cross-sectional view of the holder 417 and the etalon along a line B-B′ in FIG. 4A.

FIG. 4C illustrates a process 450 for assembling the faceplates-spacer assembly of the etalon 10, according to one embodiment of the present invention. The process 400 comprises process steps 452460. In step 452, the two faceplates 100 and the spacer 120 are arranged on the assembly fixture in the vacuum chamber 401. In step 454, the chamber is pumped to a base pressure of 5×10⁻⁶ torr. In one embodiment of the present invention, as shown in FIG. 4A, the chamber 401 is coupled to a conventional roughing pump (not shown) via a roughing valve and a plurality of conventional cryo-pump (not shown) through a hi-vacuum valve. The chamber is first pumped to a low-vacuum state using the roughing pump and then to the base pressure using the cryo-pump. Once the vacuum chamber has reached its base pressure, the linear actuator 409 is used to press the faceplates 100 and spacer 120 together (step 456). In step 458, the chamber is vented through vent 404, thereby a strong surface bond is formed between the faceplates and the spacer because of the pressure difference inside and outside of the etalon and a vacuum is sealed in the cavity of the spacer. Afterwards, the assembled etalon is removed from the vacuum chamber and sealed with a sealing cement to prevent moisture migration (step 460).

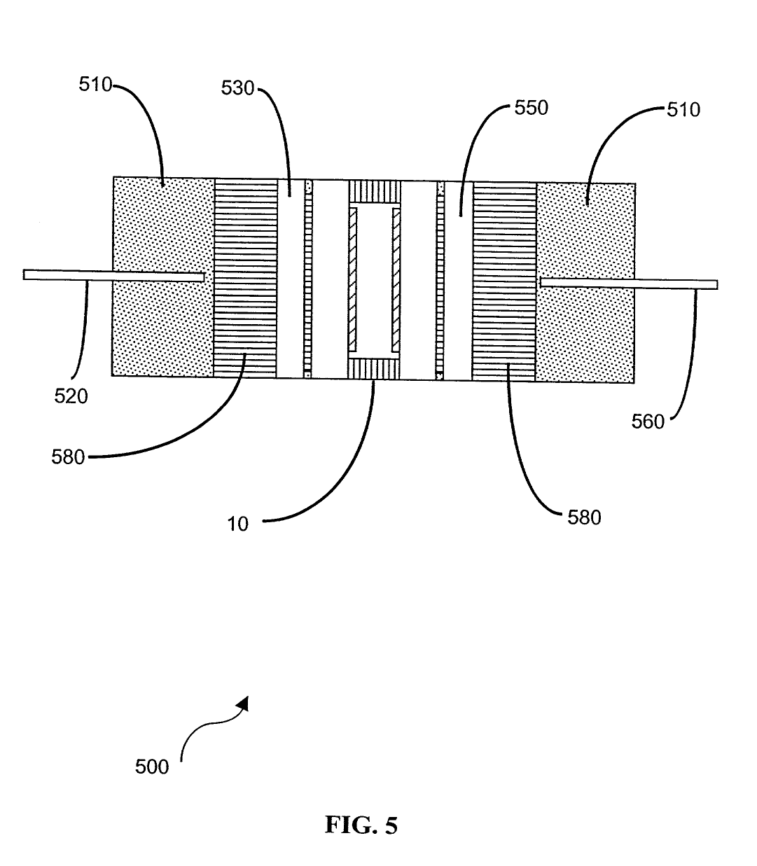

FIG. 5 illustrates a fiber assembly 500, incorporating etalon 10, that may be used in an optical fiber communication system. Fiber assembly 500 includes ferrules 510 for centering fibers 520 and 560, a graded index of refraction (GRIN) lens 530 for collimating the output of fiber 520, etalon 10 and a GRIN lens 550 for focusing the output from etalon 10 and for coupling the signal into fiber 560. Spacers 580 are optionally used as needed to align the fibers, the GRIN lenses and the etalon.

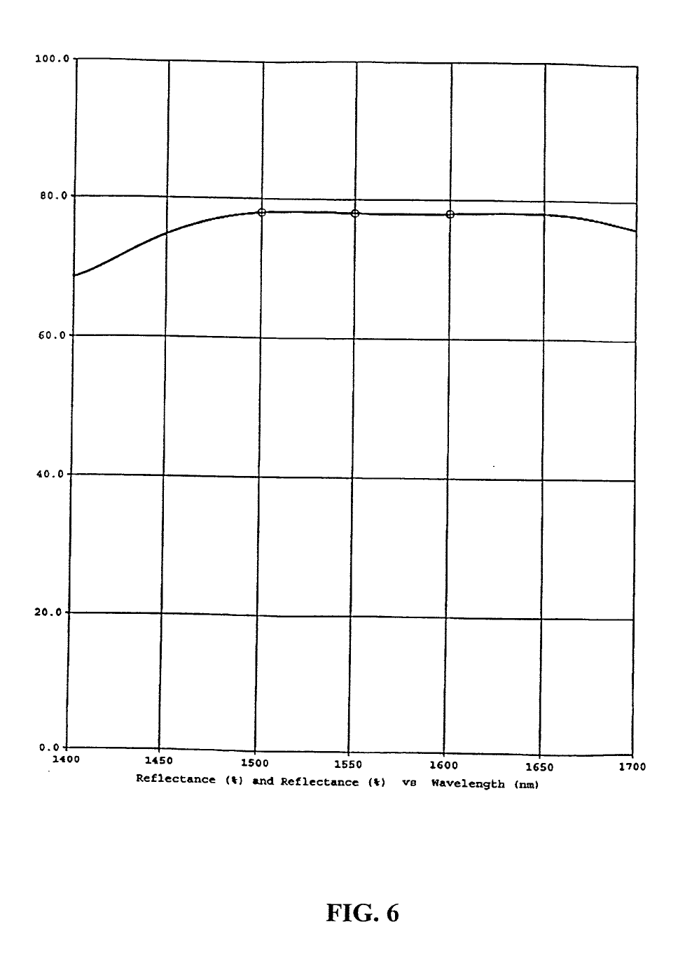

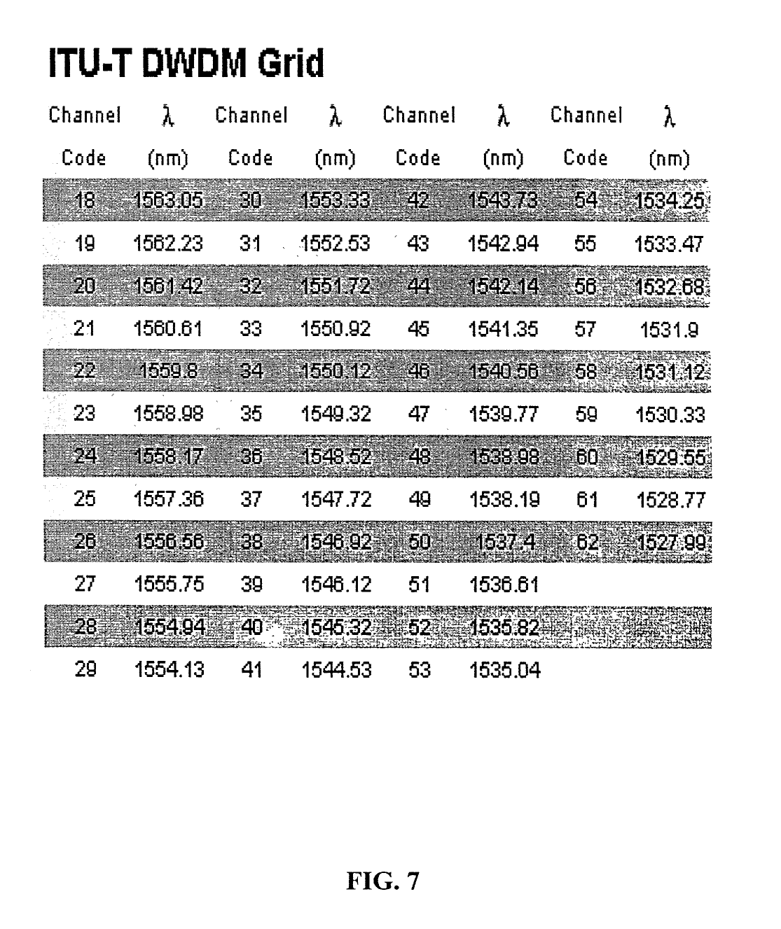

The present invention provides an etalon that can be used to stabilize the wavelength of a tunable laser. The etalon of the present invention may be used for the full range of wavelengths in the C-band. FIG. 6 shows the reflectance of multilayer reflective coating 140 in accordance with one embodiment of the invention. Those skilled in the art will appreciate that reflective coating 140 has a nearly flat response in the 1500-1600 nm range, covering the entire range of wavelengths in the International Telecommunication Union's standard ITU-T DWDM grid. (See FIG. 7). Since a single etalon can cover the entire frequency range needed, only one etalon is needed for tuning a laser to any wavelenghth in the C-band, making the etalon cost effective and particularly advantageous for a compact design desired in optical communications systems.

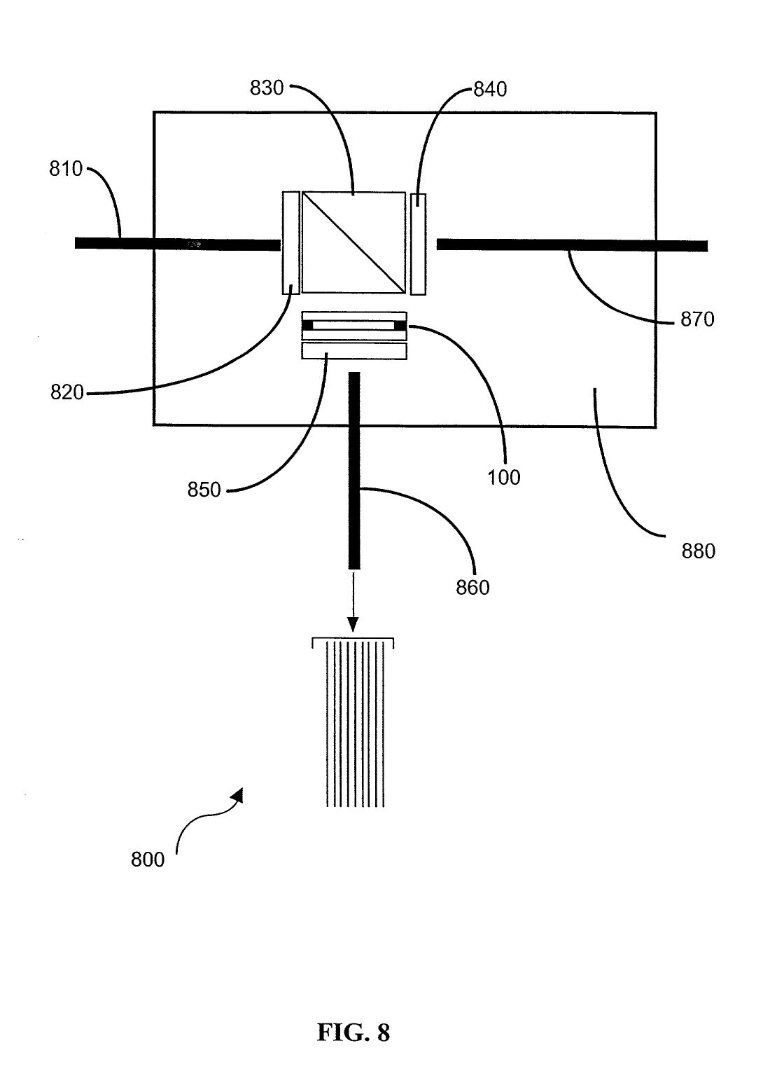

FIG. 8 illustrates a silicon optical bench 800 incorporating etalon 10. Optical bench 800 may be used as a component in a wavelength locker system for stabilizing the wavelength of tunable laser diodes commonly used in fiber optic telecommunications systems. Silicon optical bench 800 comprises a silicon substrate 880, an input fiber array 810, a collimator 820, a beamsplitter 830, etalon 10, output arrays 860 and 870, and fiber couplers 840 and 850.

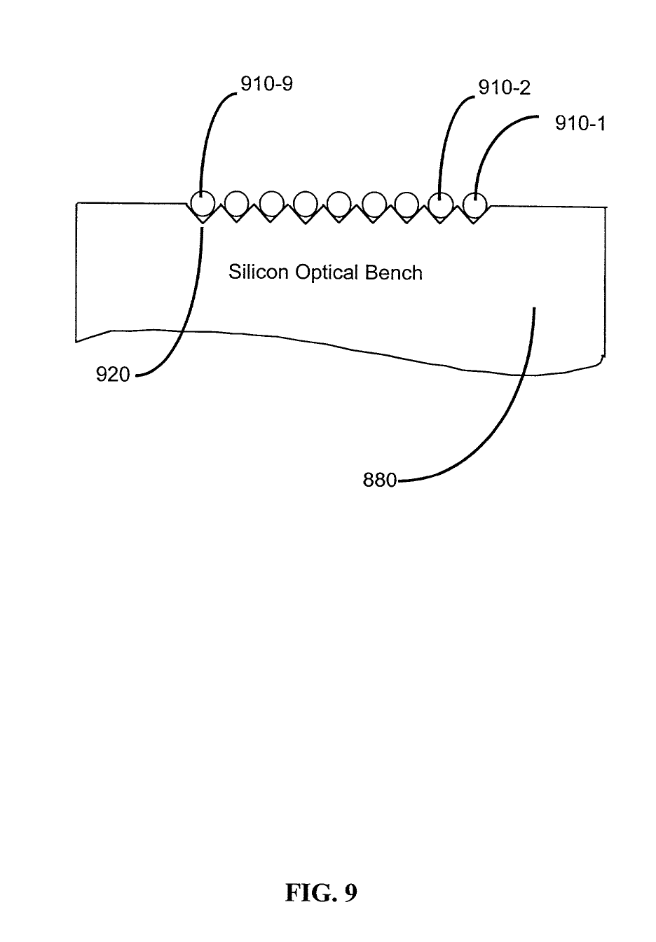

The input fiber array 810 comprises a plurality of optical fibers. In the embodiment shown in FIG. 8, fiber array 810 comprises nine input fibers 910 placed in V-grooves 920 as illustrated in FIG. 9. Similarly, output fiber arrays 860 and 870 also comprise nine fibers placed in V-grooves. The fibers can be either single mode or multimode, doped or undoped and may be made of materials other than glass. Although, FIG. 8 shows a fiber array assembly, other embodiments may use fiber bundles instead of arrays or any other means of packaging multiple fibers.

Beamsplitter 830 is any beamsplitter that will split the input light energy and can be a 50-50 beamsplitter or a polarizing beamsplitter. Collimator 820 comprises a GRIN lens assembly, with one GRIN lens for collimating the beam from each fiber in fiber array 810. Similarly, couplers 840 and 850 also comprise GRIN lens assemblies. Other types of fiber couplers and collimators may also be used. Additional components might be added to the optical assembly shown in FIG. 8 to meet additional system needs.

While the present invention has been described with reference to a few specific embodiments, the description is illustrative of the invention and is not to be construed as limiting the invention. Those skilled in the art will recognize that the etalon assembly described can be used as part of a variety of optical systems. Various modifications may occur to those skilled in the art without departing from the true spirit and scope of the invention.

What is claimed is:

1. A vacuum spaced etalon comprising
two faceplates each having an inner surface and an outer surface, a reflective coating covering at least a portion of the inner surface of each faceplate;
a spacer separating the two faceplates, wherein the two faceplates are on opposite sides and in contact with the spacer; and
the two faceplates and the spacer forming a cavity that is evacuated to provide a vacuum.

2. The vacuum spaced etalon of claim 1, wherein the inner surface of each faceplate is optically polished.

3. The vacuum spaced etalon of claim 1, wherein spacer has two surfaces each in contact with a faceplate, the two surfaces of the spacer being optically polished.

4. The vacuum spaced etalon of claim 1, wherein the reflective coating on the inner surface of each faceplate comprises alternating layers of two dielectric materials Ta₂O₅ and SiO₂.

5. The vacuum spaced etalon of claim 1, wherein at least a portion of the outer surface of at least one of the faceplates is covered with an anti-reflective coating.

6. The vacuum spaced etalon of claim 5, wherein the anti-reflective coating comprises three layers of different materials, a layer closest to the outer surface being Al₂O₃, a middle layer being Ta₂O₅, and an outer layer being MgF₂.

7. The vacuum spaced etalon of claim 1, wherein the outer surface of each faceplate is at a slight angle to the inner surface of the faceplate.

8. An optical fiber assembly comprising a vacuum spaced etalon having:
two faceplates each having an inner surface and an outer surface, a reflective coating covering at least a portion of the inner surface of each faceplate;
a spacer separating the two faceplates, wherein the two faceplates are on opposite sides and in contact with the spacer; and
the two faceplates and the spacer forming a cavity that is evacuated to provide a vacuum.

9. The optical fiber assembly of claim 8, further comprising
a first fiber for outputting a light signal to the etalon;
a second fiber for receiving an output signal from the etalon;
a first graded index reflection lens in between the first fiber and the first faceplate of the etalon for collimating the light signal from the first fiber; and
a second graded index reflection lens for focusing the output signal from the etalon and for coupling the output signal into the second fiber.

10. The optical fiber assembly of claim 9, further comprising:
a pair of ferrules each for centering a respective one of the first and second fibers.

11. The optical fiber assembly of claim 9, further comprising:
a pair of spacers each for aligning a respective one of the first and second fibers with a respective one of the first and second graded index reflection lenses and the etalon.

12. A silicon optical bench for use in a wavelength locker system to stabilize the wavelength of a tunable laser diodes used for fiber optics communication, comprising an etalon having
two faceplates each having an inner surface and an outer surface, a reflective coating covering at least a portion of the inner surface of each faceplate;
a spacer separating the two faceplates, wherein the two faceplates are on opposite sides and in contact with the spacer; and
the two faceplates and the spacer forming a cavity that is evacuated to provide a vacuum.

13. The optical bench of claim 12, further comprising:
a silicon substrate that supports the etalon;
a beamsplitter disposed on the silicon substrate, the beamsplitter having four sides facing four different directions with a first side facing the etalon;
an input fiber array directing signals toward a second side of the beamsplitter, the second side facing a direction perpendicular to a direction faced by the first side of the beamsplitter;
a collimater disposed between the input fiber and the beamsplitter;
a first output fiber array for receiving signals from a third side of the beamsplitter, the third side being opposite to the second side of the beamsplitter;
a fiber coupler disposed in between the beamsplitter and the first output fiber array;
a second output fiber array for receiving signals from the etalon; and
a fiber coupler disposed in between the etalon and the second output fiber array.

14. The silicon optical bench of claim 13, wherein the silicon substrate has groves, and each of the input fiber array, the first output fiber array and the second output fiber array comprises a plurality of fibers, and wherein each fiber is placed in a grove on the silicon bench.

15. The silicon optical bench of clam 14, wherein each grove on the silicon bench is in a V-shape.

16. The silicon optical bench of claim 13, wherein each of the input fiber array, the first output fibre array and the second output fiber array comprises a plurality of fibers arranged in a bundle.

17. A method for assembling a vacuum spaced etalon having two faceplates separated by a spacer, comprising
arranging the two faceplates and the spacer on an assembly fixture, the assembly fixture being placed in a chamber;
pumping the chamber to a base pressure;
pressing the faceplates and the spacer together to form the etalon;
venting the chamber to atmospheric pressure; and
removing the etalon from the chamber;

18. The method of claim 17, further comprising:
sealing the etalon with a sealing compound.

19. The method of claim 17, wherein the base pressure is on the order of 5×10⁻⁶ torr.

20. A system for assembling a vacuum spaced etalon having two faceplates and a spacer, comprising
a vacuum chamber having a base and a side wall, the side wall having a feedthrough for attaching a linear actuator;
a shaft having a first end coupled to the linear actuator through a coupler;
a press plate attached to a second end of the shaft;
a backing plate attached to the base of the chamber; and
a holder for supporting the faceplates and the spacer between the press plate and the backing plate, whereby when the press plate is pushed toward the backing plate using the linear actuator, the faceplates and the spacer are pressed together to form the vacuum spaced etalon.

21. The system of claim 20, wherein the holder has a grove such that the faceplates and spacer of the etalon are aligned when they are placed on the holder.

22. The system of claim 21, wherein the grove has a V-shaped cross section.
